(19) United States
(12) Patent Application Publication
(10) Pub. No.: US 2025/0249943 A1
(43) Pub. Date: Aug. 7, 2025

(54) Collapsible Trolley with Guardrail

(71) Applicant: QINGDAO SUNBELT LEISURE PRODUCTS CO., LTD, QINGDAO (CN)

(72) Inventors: Feng GAO, QINGDAO (CN); Jianmin ZHOU, QINGDAO (CN)

(73) Assignee: QINGDAO SUNBELT LEISURE PRODUCTS CO., LTD, QINGDAO (CN)

(21) Appl. No.: 18/655,339

(22) Filed: May 6, 2024

(30) Foreign Application Priority Data
Feb. 4, 2024 (CN) 202420271789.3

(51) Int. Cl. B62B 3/00; B62B 3/02; B62B 5/00; B62B 5/06

(52) U.S. Cl. CPC B62B 3/007; B62B 3/025; B62B 5/0006; B62B 5/0013; B62B 5/067; B62B 2205/06; B62B 2301/05

(57) ABSTRACT

A collapsible trolley with a guardrail includes a rack assembly, a pull handle assembly provided in front of the rack assembly, a push handle assembly fixed behind the rack assembly, a caster assembly provided at a bottom of the rack assembly, and a canopy assembly provided above the rack assembly. The rack assembly includes a bottom rack, a front frame and a rear frame respectively provided at two ends of bottom rack, and side frames respectively provided at left and right sides of the bottom rack. The front frame is connected to the pull handle assembly, and the rear frame is connected to the push handle assembly. The collapsible trolley with the guardrail avoids the problems that the prior trolleys are prone to falling under load and have small holding strength. The collapsible trolley with the guardrail is simple and labor-saving to fold up, and provides a large usable volume.

### CROSS REFERENCE TO THE RELATED APPLICATIONS

This application is based upon and claims priority to Chinese Patent Application No. 202420271789.3, filed on Feb. 4, 2024, the entire contents of which are incorporated herein by reference.

### TECHNICAL FIELD

The present disclosure relates to the technical field of trolleys, and in particular to a collapsible trolley with a guardrail.

### BACKGROUND

Collapsible trolleys are commonly used for outdoor camping or beach trips. However, there are several technical issues with the prior trolleys.

(1) After the trolley in the prior art is unfolded, the upper part of the trolley rack is surrounded by a fabric and lacks high-strength support. Therefore, when the length of the object carried by the trolley is greater than that of the trolley body, the fabric can easily be crushed.

(2) Due to the lack of guardrail protection, a kid being ferried is prone to falling out of the trolley. Further, the bottom structure of the trolley has large gaps and low strength, which leads to poor riding comfort and severe deformation after carrying heavy objects multiple times.

(3) In addition, the trolley in the prior art cannot serve a multitude of features such as pushing, pulling, caster insertion, and canopy shading.

Therefore, it is necessary to improve the holding strength of the prior trolley and the rigidity of the fabric-decorated upper end of the trolley body, solve the problems of large gaps and low strength at the bottom of the trolley body, and add multiple functions to the trolley. These have become the key technical problems to be solved by the present disclosure.

### SUMMARY

An objective of the present disclosure is to provide a collapsible trolley with a guardrail. The present disclosure solves the technical problem of integrating multiple functional technical effects on the prior trolley, increases the load-bearing capacity and holding strength of the trolley, and reduces the gaps at the bottom of the trolley. The trolley provided by the present disclosure is simple and labor-saving to fold up, provides a large usable volume, and takes up little space after being folded, greatly enhancing the practical performance of the trolley.

A collapsible trolley with a guardrail includes a rack assembly, a pull handle assembly provided in front of the rack assembly, a push handle assembly fixed behind the rack assembly, a caster assembly provided at a bottom of the rack assembly, and a canopy assembly provided above the rack assembly.

The rack assembly includes a bottom rack, a front frame and a rear frame respectively provided at two ends of the bottom rack, and side frames respectively provided at left and right sides of the bottom rack; the front frame is connected to the pull handle assembly; and the rear frame is connected to the push handle assembly; and
each of the front frame and the rear frame includes a horizontal tube, vertical tubes (short vertical tubes for the front frame and long vertical tubes for the rear frame) respectively welded to two ends of the horizontal tube, and a guardrail tube passing through tube sleeves respectively hinged to upper ends of the vertical tubes; and the guardrail tube is U-shaped and slidable in the tube sleeves.

Each of the side frames includes two X-shaped cross-tube assemblies and a connecting element; each of the cross-tube assemblies includes a long tube and a short tube; and the long tube is hinged to the short tube through a first hole in a middle of a side of the long tube and a second hole in a middle of a side of the short tube, thereby forming an X-shaped crossing;
the two long tubes include ends respectively hinged to the horizontal tubes or L-shaped elements of the front frame and the rear frame and the other ends hinged to the connecting element; and two free ends of the two guardrail tubes are hinged to the connecting element of a same side frame; and
the two short tubes include ends hinged together and the other ends respectively hinged to two sliding sleeves or double-end sliders; and the two sliding sleeves are respectively slidable up and down on the vertical tubes of the front frame and the rear frame.

The bottom rack includes a front bottom rack and a rear bottom rack; a front end of the front bottom rack is hinged to the horizontal tube of the front frame, and a rear end of the front bottom rack is hinged to a front end of the rear bottom rack; and
a rear end of the rear bottom rack is hinged to the horizontal tube of the rear frame, and a top of the front end of the rear bottom rack is transversely fixed to a steel strip; and the steel strip is behind a hinge hole of the front bottom rack and extends beyond the front end of the front bottom rack.

When the front bottom rack and the rear bottom rack are leveled, the steel strip is pressed on the front bottom rack to play a limiting role.

The pull handle assembly includes a link seat, two lower links with ends respectively connected to two sides of the link seat at an angle, a horizontal tube with two ends respectively connected to the two lower links, and an upper link vertically and slidably passing through a center of the link seat; the two lower links are symmetrically distributed about a central axis of the upper link; the two ends of the horizontal tube are respectively connected to the other ends of the two lower links through pin shafts; and the pin shafts are respectively connected to torsion springs; and
a lever button is slidably provided inside a pull handle lever; the lever button is fixed to a top of the upper link; one end of the upper link is integrally connected to the pull handle lever; and a locking mechanism controlled by a pull handle button is provided in the upper link.

The locking mechanism includes a steel bar with one end pushed against the lever button and a pressing element fixedly connected to the other end of the steel bar; the pressing element is located above two limiting elements and inserted into a tube plug together with the two limiting elements; and a spring is located between the two limiting elements; and
a lower part of the pressing element is provided with a V-shaped opening; and two slopes of the V-shaped opening are respectively tangent to slopes of the limiting elements.

The caster assembly includes a front caster assembly and a rear caster assembly; and the front caster assembly and the rear caster assembly are consistent in structure; and
the front caster assembly or the rear caster assembly includes a caster carrier, a tire connected to the caster carrier through a pin shaft, a caster stem with an end fixed to a top of the caster carrier, and a stem sleeve sleeved on an outer side of the caster stem; and a quick release button and a spring are provided in a transverse square hole at an upper end of the stem sleeve and pressed into a lower end of the vertical tube of the front frame or the rear frame.

The canopy assembly includes an upper canopy seat, a lower canopy seat connected to a lower end of the upper canopy seat through a pin, two transverse support tubes with ends respectively hinged to an outer side of the upper canopy seat, two transverse support tubes with ends respectively hinged to an outer side of the lower canopy seat, side seats respectively hinged to the other ends of the four transverse support tubes, and vertical posts with respective upper ends inserted into the side seats and lower ends inserted into canopy fixing seats; and the canopy fixing seats are respectively fixed to the guardrail tubes.

The guardrail tube can also be formed into a telescopic structure.

The present disclosure has the following remarkable effects.

(1) In the present disclosure, the trolley is provided with a front frame, side frames, and a rear frame, which are matched with a front rack and a rear rack, making the trolley easy to fold and unfold and save space.

The pull handle assembly, the push handle assembly, and the canopy assembly add functions to the trolley, improving the user experience and enhancing user satisfaction.

The present disclosure increases the load-bearing capacity and holding strength of the trolley, and reduces the gaps at the bottom of the trolley. The trolley provided by the present disclosure is simple and labor-saving to fold up, provides a large usable volume, and takes up little space after being folded, greatly enhancing the practical performance of the trolley.

(2) In the present disclosure, the collapsible trolley is simple and labor-saving in folding, and provides a large usable volume. After being folded, the trolley takes up little space and can be placed in the trunk of a car or in a narrow indoor space. In addition, the trolley has light weight and good stability.

(3) In the present application, the trolley has two ways of folding. First, after being folded, the trolley is in a piece shape. Second, when the trolley is folded, the trolley gets closes towards the center. The diversified folding ways apply according to actual situations and can achieve a wide range of application prospects.

### BRIEF DESCRIPTION OF THE DRAWINGS

FIG. 1 is a schematic diagram of a trolley, with a canopy, in an unfolded state, according to Embodiment 1 of the present disclosure;

FIG. 2 is a schematic diagram of the trolley, with a canopy rack, in an unfolded state, according to Embodiment 1 of the present disclosure;

FIG. 3 is an exploded view of the trolley according Embodiment 1 of the present disclosure;

FIG. 4 is a schematic diagram of a front frame according to Embodiment 1 of the present disclosure;

FIG. 5 is a schematic diagram of a rear frame according to Embodiment 1 of the present disclosure;

FIG. 6 is a schematic diagram of a side frame according to Embodiment 1 of the present disclosure;

FIG. 7 is a schematic diagram of a bottom rack according to Embodiment 1 of the present disclosure;

FIG. 8A is an exploded view of a pull handle assembly according to Embodiment 1 of the present disclosure;

FIG. 8B is a schematic diagram of a lever button in a released state according to Embodiment 1 of the present disclosure;

FIG. 8C is a schematic diagram of the lever button in a pressed state according to Embodiment 1 of the present disclosure;

FIG. 9 is an exploded view of a front caster assembly according Embodiment 1 of the present disclosure;

FIG. 10A is an exploded view of a rear caster assembly according Embodiment 1 of the present disclosure;

FIG. 10B is a structural diagram of a caster stem in a locked state according Embodiment 1 of the present disclosure;

FIG. 10C is a structural diagram of the caster stem in an unlocked state according Embodiment 1 of the present disclosure;

FIG. 10D is an exploded view of the caster stem in the unlocked state according Embodiment 1 of the present disclosure;

FIG. 11 is an exploded view of a canopy assembly according Embodiment 1 of the present disclosure;

FIG. 12A is a structural diagram of a push handle assembly according to Embodiment 1 of the present disclosure;

FIG. 12B is a first structural diagram of the trolley in a folded state according to Embodiment 1 of the present disclosure;

FIG. 12C is a second structural diagram of the trolley in a folded state according to Embodiment 1 of the present disclosure;

FIG. 12D is a third structural diagram of the trolley in a folded state according to Embodiment 1 of the present disclosure;

FIG. 13 is an exploded view of a collapsible trolley according Embodiment 2 of the present disclosure;

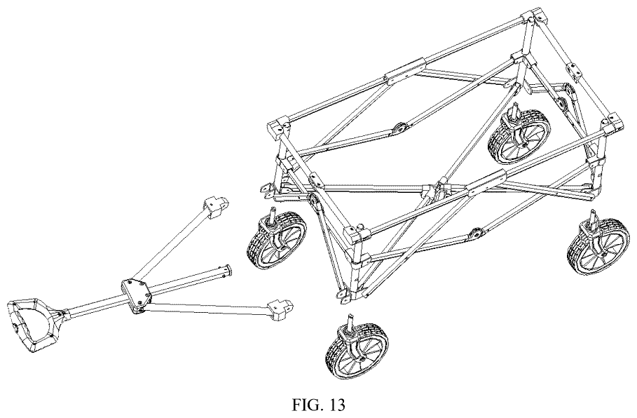

FIG. 14 is a structural diagram of a front frame according to Embodiment 2 of the present disclosure;

FIG. 15A is a structural diagram of a bottom rack according to Embodiment 2 of the present disclosure;

FIG. 15B is a schematic diagram of a trolley rack in an unfolded state, according to Embodiment 2 of the present disclosure;

FIG. 15C is schematic diagram of a side frame in a folded state according to Embodiment 2 of the present disclosure; and

FIG. 15D is a schematic diagram of the trolley rack in a folded state, according to Embodiment 2 of the present disclosure.

Reference Numerals: 1. canopy assembly; 11. vertical post; 12. side seat; 13. transverse support tube; 15. upper canopy seat; 14. lower canopy seat; 2. push handle assembly; 21. push tube; 22. angle adjuster; 3. rear caster assembly; 31. U-shaped groove; 32. tire; 33. caster carrier; 34. caster stem; 35. stem sleeve; 36. quick release button; 361. button part; 362. clamping groove part; 363. connecting part; 37. spring; 4. front caster assembly; 41. side guardrail tube; 42. sliding sleeve; 43. guardrail tube seat; 44. double-end slider; 441. foldable short tube; 45. vertical tube; 46. L-shaped element; 47. front guardrail tube; 471. guardrail tube hinge seat; 48. link seat; 481. foldable long tube; 49. canopy fixing seat; 5. pull handle assembly; 50. torsion spring; 51. lower link; 52. link seat; 53. upper link; 54. limiting element; 55. tube plug; 56. spring; 57. pressing element; 58. steel bar; 59. lever button; 6. rack assembly; 60. pull handle lever; 61. guardrail tube; 62. tube sleeve; 63. long vertical tube; 64. sliding sleeve; 65. horizontal tube; 66. short vertical tube; 67. connecting element; 68. long tube; 69. short tube; 70. rear bottom rack; 71. steel strip; 80. front bottom rack; 91. bottom support tube; 92. U-shaped weld element; and 93. center support seat.

### DETAILED DESCRIPTION OF THE EMBODIMENTS

To clearly explain the technical characteristics of the solution of the present disclosure, the solution of the present disclosure is described below according to specific implementations.

### Embodiment 1

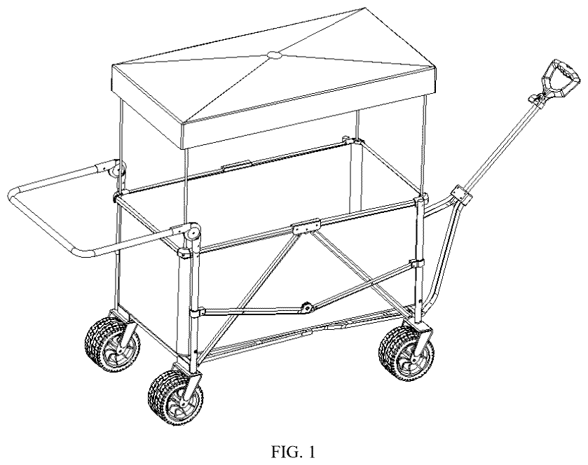

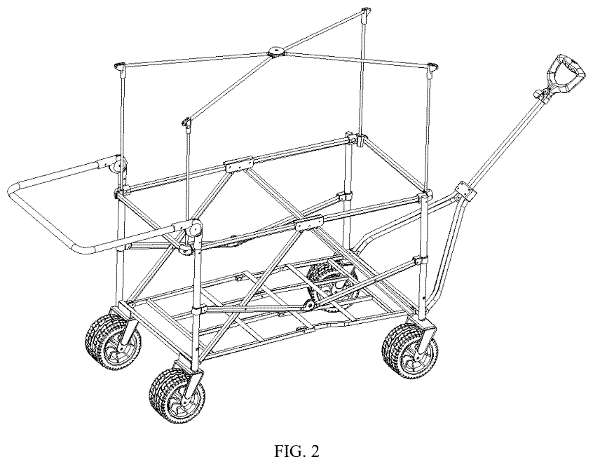

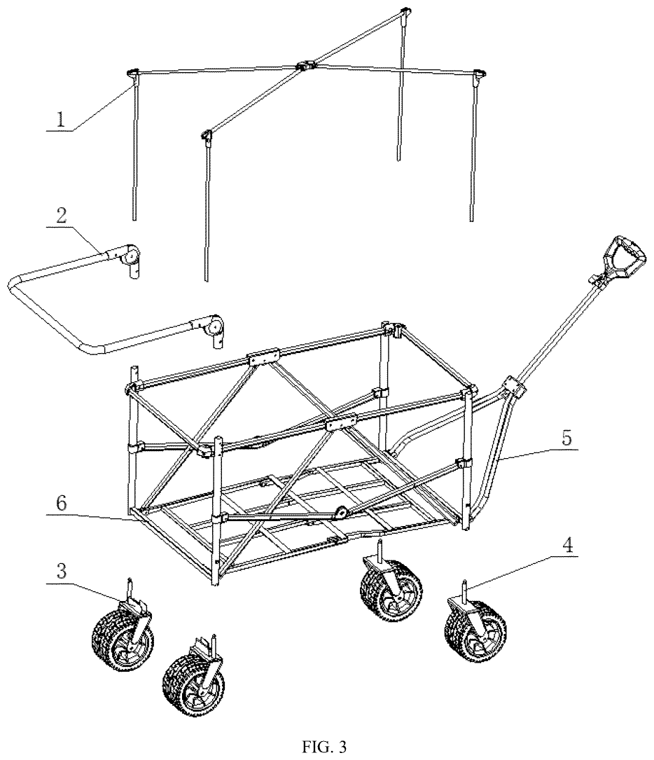

The present disclosure provides a collapsible trolley, including: rack assembly 6, push handle assembly 2, pull handle assembly 5, two front caster assemblies 4, two rear caster assemblies 3, and canopy assembly 1 (FIGS. 1 to 3). The rack assembly includes a front frame, two side frames, a rear frame, and a bottom rack.

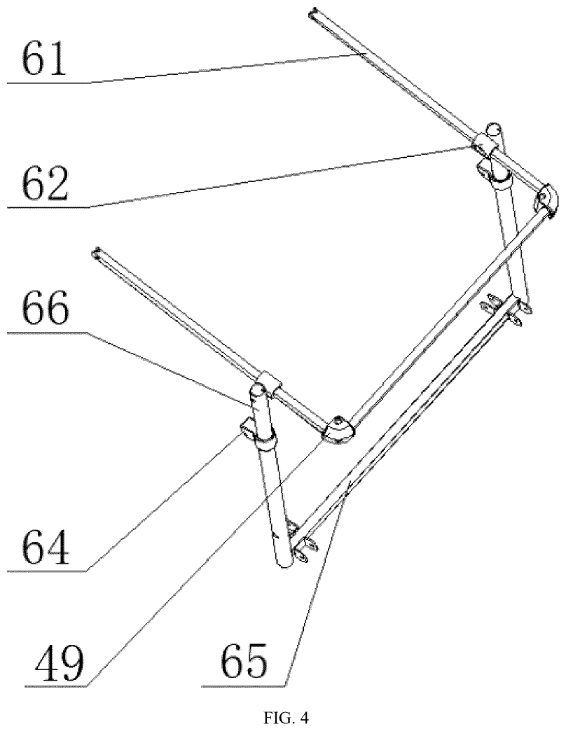

The front frame includes U-shaped guardrail tube 61, horizontal tube 65, and two vertical short vertical tubes 66 respectively located at two ends of the horizontal tube (FIG. 4).

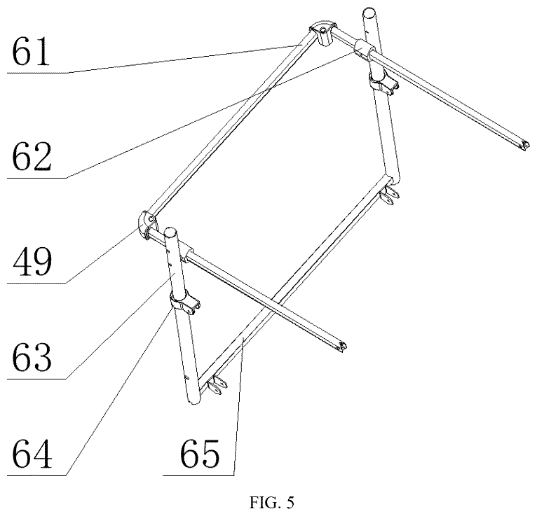

The rear frame includes U-shaped guardrail tube 61, horizontal tube 65, and two vertical long vertical tubes 63 located at two ends of the horizontal tube (FIG. 5). Two ends of the guardrail tube 61 respectively pass through tube sleeves 62. For the front frame, the tube sleeve 62 is rotatably connected to an upper part of the short vertical tube 66. For the rear frame, the tube sleeve 62 is rotatably connected to an upper part of the long vertical tube 63. The guardrail tube is slidable back and forth in the tube sleeve 62 and rotatable with the tube sleeve 62. The two long vertical tubes are respectively nested inside sliding sleeves 64 that are movable up and down. There are two canopy fixing seats 49 fixed to the guardrail tube 61.

Therefore, in the present disclosure, for the front frame, the vertical tube refers to the short vertical tube 66, while for the rear frame, the vertical tube refers to the long vertical tube 63.

In addition, there is no distinction between the horizontal tubes 65 of the front frame and the rear frames, but the description will indicate whether the horizontal tube 65 is located in the front frame or the rear frame.

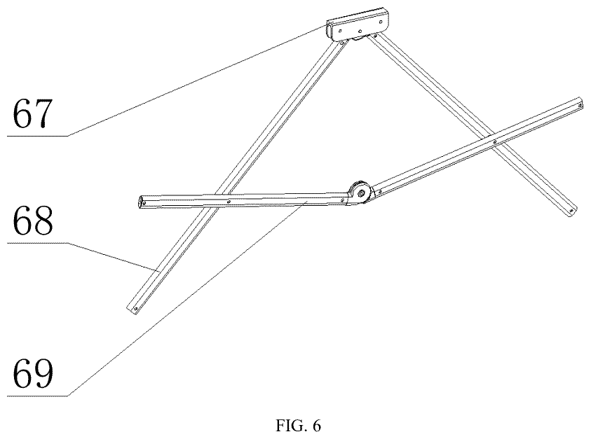

The side frame includes two X-shaped cross-tube assemblies (FIG. 6). In the two X-shaped cross-tube assemblies, upper ends of long tubes 68 are hinged together and are respectively hinged to the guardrail tubes 61 of the front frame and the rear frame through connecting element 67. A lower end of one long tube 68 is hinged to the horizontal tube 65 of the front frame, while a lower end of the other long tube 68 is hinged to the horizontal tube 65 of the rear frame. In the two X-shaped cross-tube assemblies, lower ends of short tubes 69 are hinged together. An upper end of one short tube is hinged to the sliding sleeve 64 of the front frame, while an upper end of the other short tube is hinged to the sliding element 64 of the rear frame.

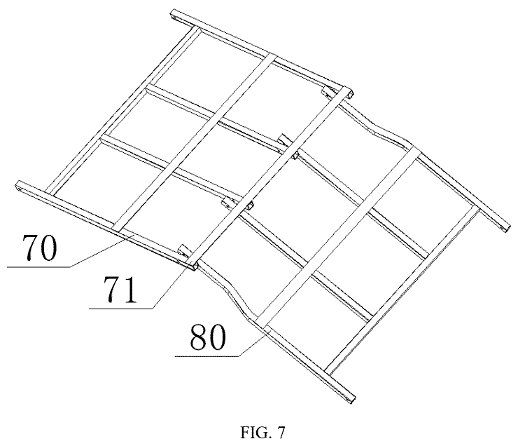

The two side frames, the front frame, and the rear frame are connected end to end to form a rectangular frame structure (FIG. 7).

The bottom rack includes front bottom rack 80 and rear bottom rack 70 (FIG. 7). An upper plane at one end of the rear bottom rack 70 is fixedly provided with steel strip 71 and is hinged to one end of the front bottom rack 80 through a round hole at a back of the steel strip 71. The other end of the rear bottom rack 70 is hinged to the horizontal tube 65 of the rear frame. The other end of the front bottom rack 80 is hinged to the horizontal tube 65 of the front frame. When the steel strip 71 on the upper plane of the rear bottom rack 70 is in a horizontal position, it is pressed on the front bottom rack 80 to limit downward movement.

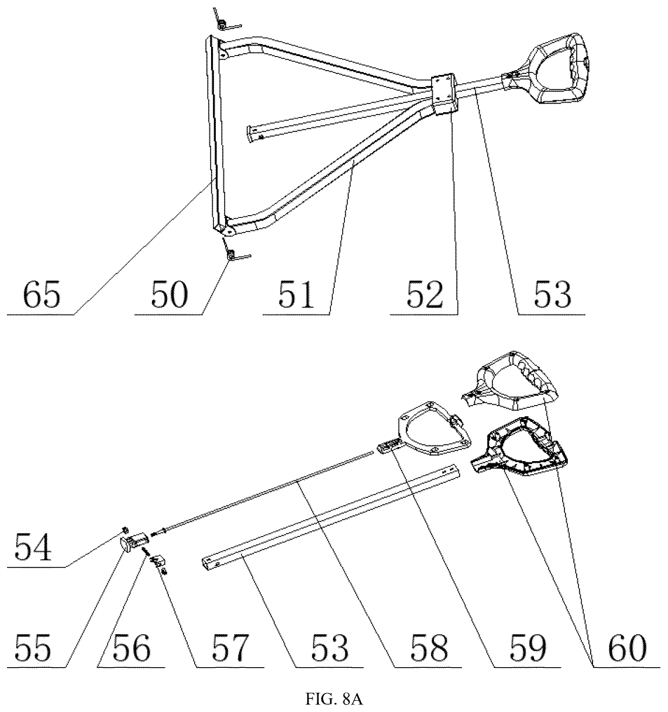

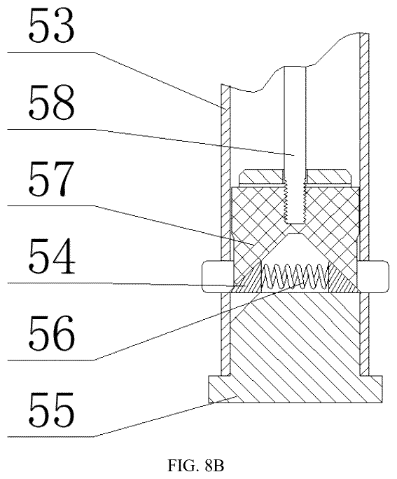

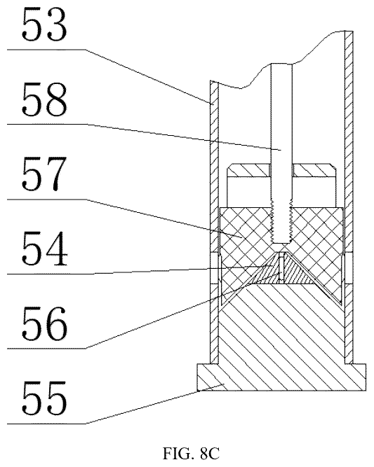

As shown in FIG. 8A, pull handle lever 60 wrapping lever button 59 is located at an upper end of upper link 53. The upper link 53 passes through a center hole of link seat 52 and is movable up and down in the hole. Upper ends of two lower links 51 are symmetrically inserted into two sides of the link seat 52. Lower end openings of the two lower links 51 are respectively provided therein with torsion springs 50 and are hinged to the horizontal tube 65 of the front frame through bolts, such that they can automatically rebound to a position perpendicular to a ground without an external force.

The lever button 59 is inserted into the upper link 53 and integrally connected to pressing element 57 through steel bar 58. Two V-shaped slopes of the pressing element 57 are respectively adhered to slopes of two limiting elements 54 of tube plug 55. The tube plug 55 is integrally fixed to the upper link 53.

In specific work, as shown in FIG. 8B and FIG. 8C, when the lever button 59 is pressed, the steel bar 58 and the pressing element 57 are pushed downwards. The two limiting elements 54 move inward to get close under the action of the V-shaped slopes, causing the two limiting elements 54 protruding from the upper link 53 to retract into the upper link 53. That is, middle protrusions of the two limiting elements 54 that are pushed against an inner wall of the upper link 53 by the spring 56 pass through holes of the upper link 53 and are exposed out of the tube. The slopes at the two sides of the protrusion are pushed against the inner wall of the upper link 53. When the pressing element 57 moves downwards, lower planes of the limiting elements 54 are pushed against the tube plug 55. In this way, the spring 56 can only be compressed inward along a horizontal direction, allowing the spring 56 to enter a hole of the limiting element 54, thereby driving the protrusion to retract into the upper link 53. When the lever button 59 is released, the spring 56 between the two limiting elements 54 pushes the limiting elements 54 outward, causing them to protrude from the upper link 53. Meanwhile, the pressing elements 57 are pushed through the slopes to return the lever button 59 to its initial position. That is, the limiting elements 54 are pushed and translated by the spring 56 to two sides and pass through the holes of the upper link 53 until the limiting elements 54 are pushed against the inner wall of the upper link 53. When the limiting elements 54 move outward, their slopes move along the slopes of the pressing element 57, thereby pushing the pressing element 57.

When the pull handle lever 60 is lifted, the upper link 53 slides in the center hole of the link seat 52 until a base of the tube plug 55, which is larger than the hole, is pushed against a lower plane of the link seat 52. At this point, the two limiting elements 54 fall into limit holes of the link seat 52, preventing the pull handle lever 60 from being lifted or pressed back down.

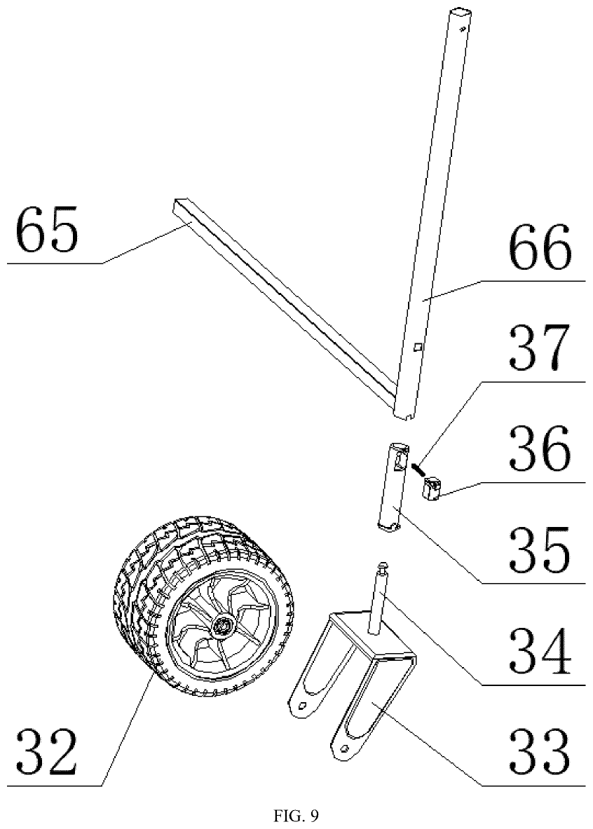

The front caster assembly includes caster stem 34, caster carrier 33, tire 32, caster stem sleeve 35, quick release button 36, and spring 37 (FIG. 9). The caster stem 34 is vertically welded to an upper plane of the caster carrier 33. The tire 32 is sandwiched between two side plates of the caster carrier 33 and is connected by pins. The quick release button 36 and the spring 37 therein are horizontally inserted into the caster stem sleeve 35 and threaded into the short vertical tube 66 of the front frame along with the caster stem sleeve 35. The quick release button 36 can be exposed from an opening of the short vertical tube 66 under the action of the spring 37.

The quick release button 36 includes button part 361, clamping groove part 362, and connecting part 363, which form a whole. The clamping groove 362 is provided with a gourd-shaped opening, including a large circle and a small circle that are connected to each other. When the button part 361 is pressed, the caster stem sleeve 35 is concentric with the large circle of the clamping groove part 362. When the button is released, the caster stem sleeve 35 is concentric with the small circle of the clamping groove part 362 under the action of the spring 37. During the mounting of the front caster assembly, the caster stem 34 is aligned with an opening of the caster stem sleeve 35 and inserted upwards. A chamfer at a top of the caster stem 34 pushes the quick release button 36 towards a side of the spring 37, causing a circular groove at an upper end of the caster stem 34 to pass through the large circle of the clamping groove part 362.

A diameter of a groove of the caster stem 34 is equal to a diameter of the small circle at the clamping groove part 362. Therefore, the small circle is clamped into the groove of the caster stem 34 under the action of the spring 37, such that the caster stem 34 can only rotate and cannot move up or down. During disassembly, the button part 361 of the quick release button 36 is pressed down to the bottom, such that the large circle of the clamping groove part 362 is concentric with the caster stem sleeve 35, and then the caster stem 34 can be forcefully pulled out downwards.

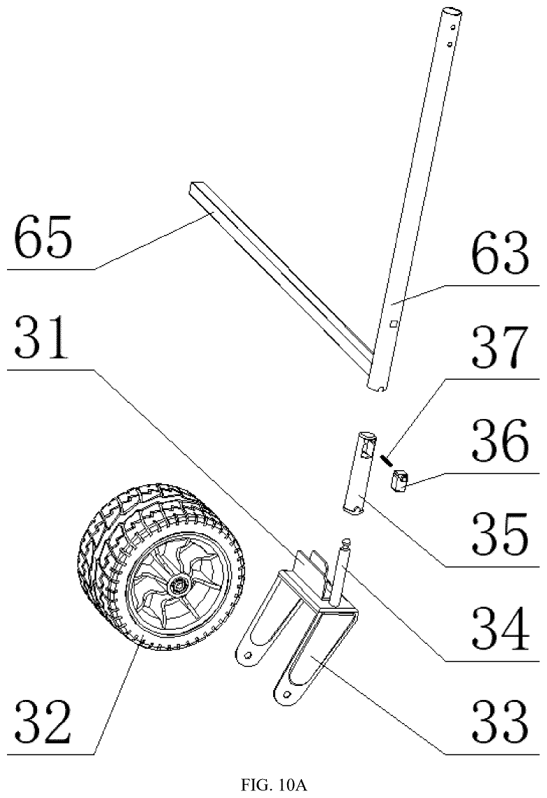

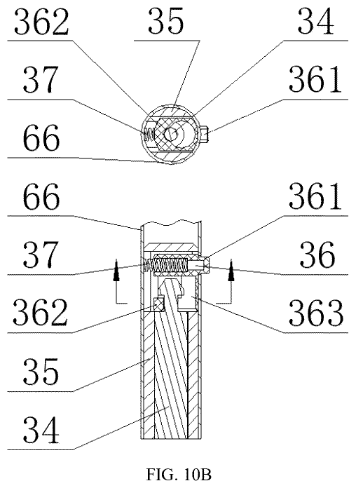

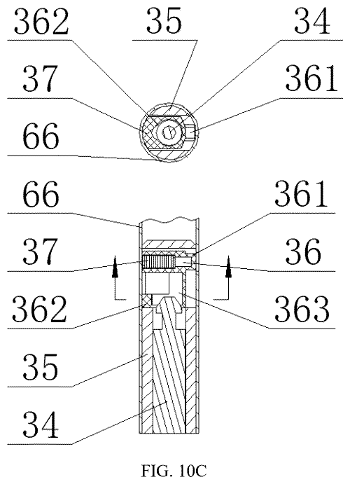

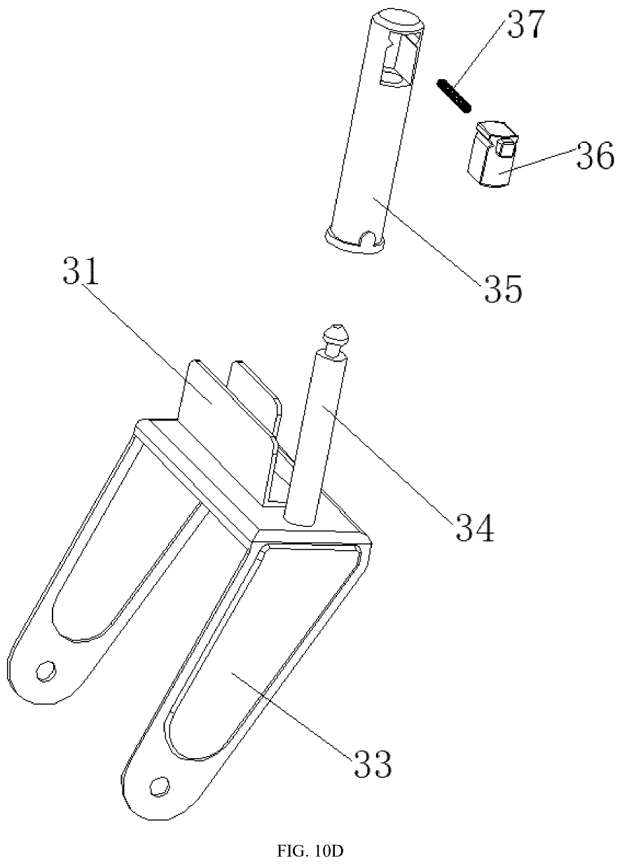

In a specific working process of the shortcut button 36, as shown FIGS. 10B and 10C, when the button part 361 is pressed down, the spring 37 is compressed, and the connecting part 363 drives the integrally connected clamping groove part 362 to move towards an inner side of the short vertical tube 66. At this point, the top of the caster stem 34 changes from being concentric with the small circle of the clamping groove part 362 to being concentric with the large circle of the clamping groove part 362 and being in a separated state. At this point, the caster stem 34 can be pulled out downwards.

When the clamping groove part 362 is engaged with the top opening of the caster stem 34, the top of the caster stem 34 contacts a bottom surface of the clamping groove part 362. The top of the caster stem 34 and edges of the large and small circular holes in the clamping groove part 362 are chamfered. When the caster stem 34 is pushed up, its top chamfer is pressed against the chamfer of the small circle to push the quick release button 36 and compress the spring 37. Thus, the caster stem is concentric with the large circle and passes through it to enter the connecting part 363 until the groove at the top of the caster stem 34 is in the same plane as the clamping groove part 362. At this point, under the action of the spring 37, the small circle of the clamping groove part 362 is pushed into the groove and restored to be concentric with the caster stem 34. The button part 361 passes through the hole of the short vertical tube 66 and extends out of the tube.

The rear caster assembly includes caster stem 34, caster carrier 33, U-shaped groove 31, tire 32, stem sleeve 35, quick release button 36, and spring 37 (FIG. 10D). The U-shaped groove 31 is welded to the other side of an upper plane of the caster carrier. The long vertical tube 63 is different from the short vertical tube 66. In addition, the connection and assembly methods of other components are the same or similar to those of the front caster assembly, which will not be elaborated here. Please refer to the front caster assembly.

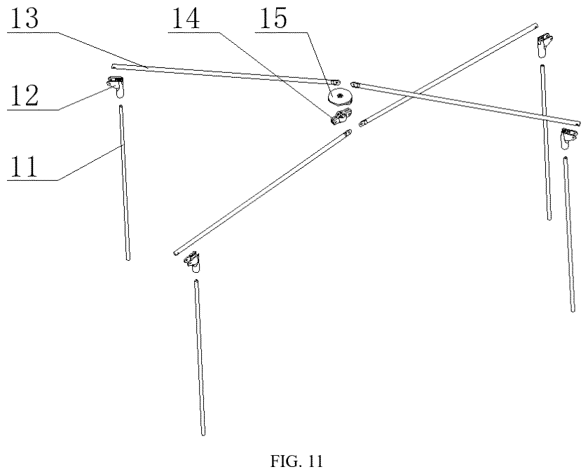

The canopy assembly includes four vertical posts 11, four side seats 12, four transverse support tubes 13, one upper canopy seat 15, and one lower canopy seat 14 (FIG. 11). The vertical post 11 is inserted into a lower end of the side seat 12, and an upper end of the side seat 12 is hinged to the transverse support tube 13. The other ends of two transverse support tubes 13 are respectively hinged to two sides of the upper canopy seat 15. The other ends of the other two transverse support tubes 13 are respectively hinged to two sides of the lower canopy seat 14. The transverse support tubes 13 are rotatable by 90° around a hinge axis of the upper canopy seat 15 or the lower canopy seat 14. The side seat is rotatable by 270° around a hinge axis of the transverse support tube 13. The upper canopy seat 15 is connected to the lower canopy seat 14 through a pin. A lower end of the vertical post 11 into the canopy fixing seat 49 fixed to the guardrail tube 61.

To fold the canopy, firstly, one vertical post 11 is pulled out of the canopy fixing seat 49 and rotated 270° to make it parallel to the transverse support tube 13. Then, the transverse support tube 13 is rotated downwards by 90°, such that the transverse support tube 13 and the vertical post 11 are perpendicular to the upper canopy seat 15. According to the steps, the remaining three sets of transverse support tubes 13 and vertical posts 11 are folded in sequence. To unfold the canopy, the steps are reversed.

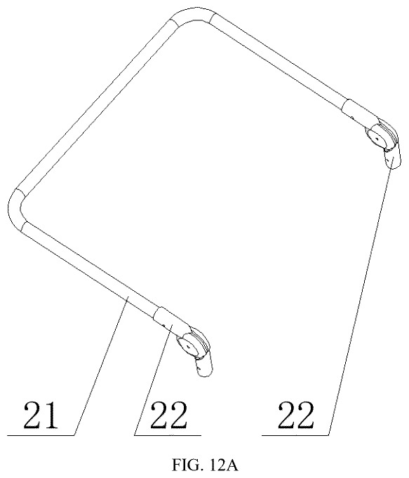

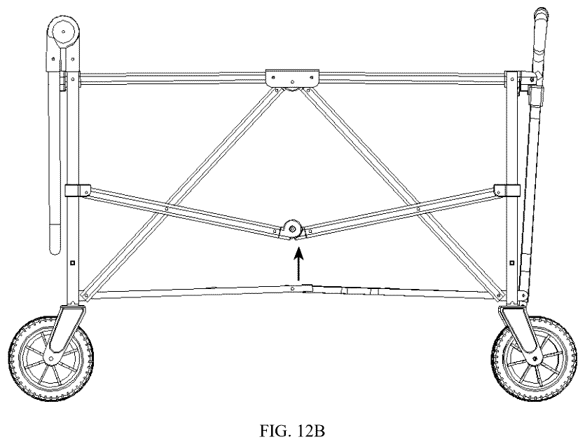

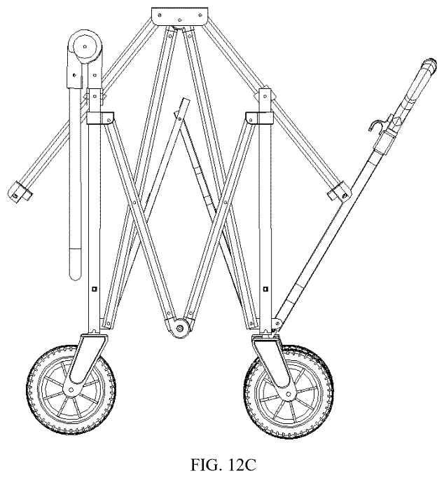

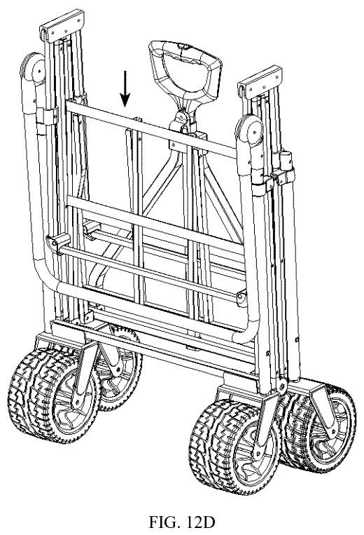

The push handle assembly includes push tube 21 and two angle adjusters 22 (FIG. 12A). One end of each of the two angle adjusters 22 is inserted into an upper end of the long vertical tube 63 of the rear frame, while the other end thereof is inserted into the push tube 21.

As shown in FIGS. 12B, 12C, and 12D, to fold the trolley, the steel strip 71 on the rear bottom rack 70 of the trolley rack is lifted, and the front bottom rack 80 and the rear bottom rack 70 are rotated around the hinge axis to get close, thereby driving the horizontal tubes 65 of the front frame and the rear frame to get close inward. The two long tubes 68 of the side frame also get close inward. For the two X-shaped cross-tube assemblies of the side frame, the inward get-close of the long tubes 68 drives the inward get-close of the two short tubes 69. The sliding sleeves 64 respectively slide upwards on the short vertical tube 66 of the front frame and the long vertical tube 63 of the rear frame, causing the front frame and the rear frame to get close inward. As the long tubes 68 get close and rise, the guardrail tube 61 hinged at the two sides of the connecting element 67 gradually rise. Due to the fixed height of the tube sleeves 62, the guardrail tube 61 that passes through the tube sleeves 62 can only rotate with the tube sleeves 62 and slide downwards until the front and rear casters collide.

To unfold the trolley, the steel strip 71 on the rear bottom rack 70 of the trolley rack is pressed down, such that the front bottom rack 80 and the rear bottom rack 70 rotate around the hinge axis and are opened out. Meanwhile, the two long tubes 68 of the side frame are opened out, and the short tubes 69, which form an X-shaped crossing with the two long tubes, are opened out. The sliding sleeves 64 slide downwards on the short vertical tubes 66 of the front frame and the long vertical tubes 63 of the rear frame, thereby pushing the front frame and the rear frame outward. The guardrail tube 61 rotates with the tube sleeve 62 and slides upward until the steel strip 71 on the rear bottom rack 70 of the trolley rack is pressed onto a steel tube of the front bottom rack 80.

### Embodiment 2

Embodiment 2 is improved on the basis of Embodiment 1, reducing the folded volume of the trolley. Mainly, the structures of the front frame, the rear frame, and the bottom rack are Embodiment 1 is changed to X-shaped crossed structures, and the corresponding fixing manner of the lower link and the link seat is changed to a hinged manner. Other structures not mentioned are basically the same as those in Embodiment 1, so the complete technical solution of Embodiment 2 can be derived based on the drawings of Embodiment 1.

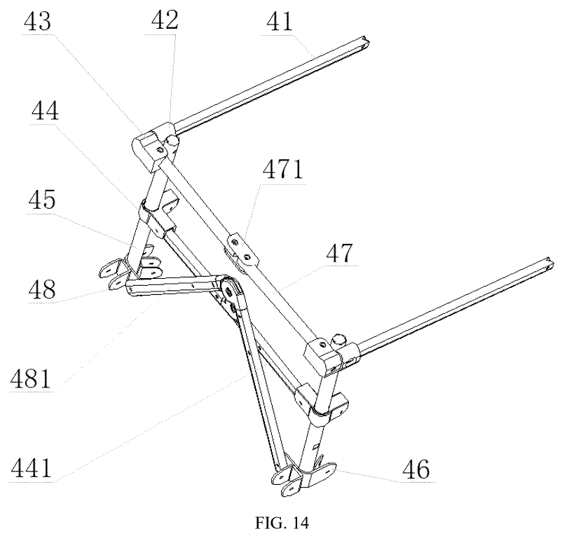

For the structure of the front frame (FIG. 14), the vertical tube 45 is provided with double-end slider 44. A lower end of the vertical tube is welded to L-shaped element 46. An iron element is welded to link seat 48. The vertical tube 45 located at an inner side of the iron element is welded to bottom rack seat 42. An upper end of the vertical tube 45 is hinged to the rotatable tube sleeve 62. Side guardrail tube 41 passes through the tube sleeve 62

Foldable long tube 481 and foldable short tube 441 are hinged to form an X-shaped crossed structure. For two X-shaped crossed structures, upper ends of the foldable long tubes 481 are hinged together, and lower ends of the foldable long tubes are respectively hinged to the L-shaped elements 46 at the lower ends of the vertical tubes 45. For the two X-shaped crossed structures, closer ends of the foldable short tubes 441 are hinged together, and farther ends of the foldable short tubes are respectively hinged to the double-end sliders 44. One end of front guardrail tube 47 is hinged to guardrail tube seat 43, and the other end of the front guardrail tube is hinged to guardrail tube hinge seat 471. One end of the side guardrail tube 41 is hinged to the guardrail tube seat 43 and is slidable in the sliding sleeve 42.

The structure of the rear frame is the same as that of the front frame, except that two link seats 48 are missing from the rear frame. The structure of the rear frame will not be elaborated further.

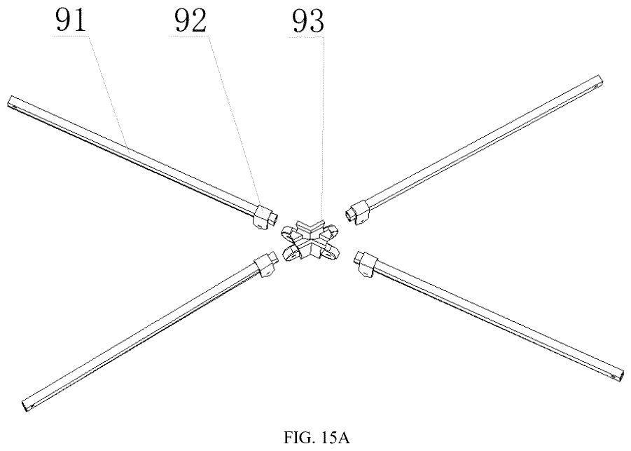

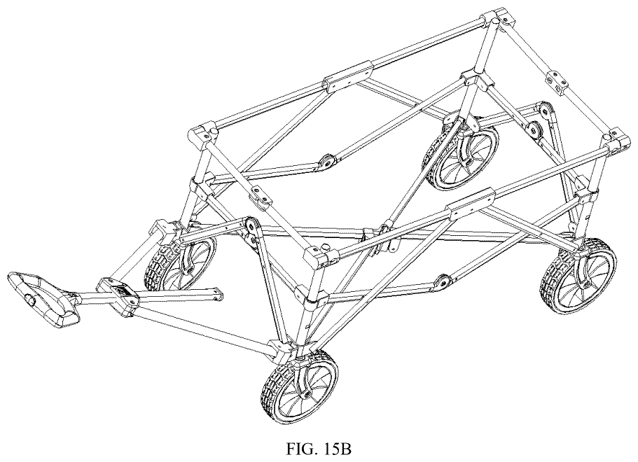

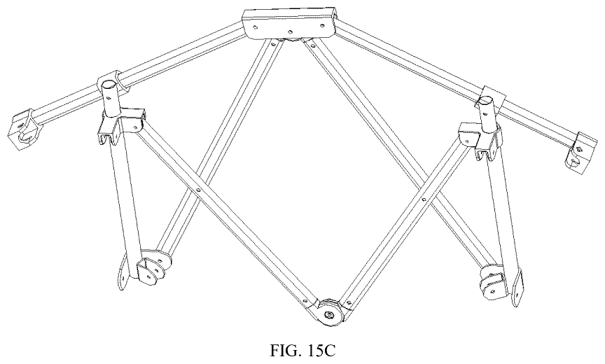

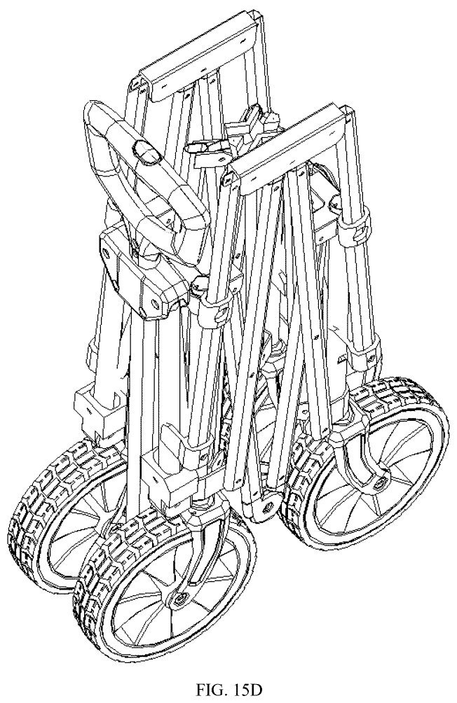

The bottom rack (FIG. 15A) includes center support seat 93, four U-shaped weld elements 92 hinged to an outer side of the center support seat 93, and bottom support tubes 91 welded to the U-shaped weld elements 92. The other end of the bottom support tube 91 is hinged to the bottom rack seat 42 at the lower end of the vertical tube 45.

The bottom rack includes four bottom support tubes 91, four U-shaped weld elements 92, and one center support seat 93. The U-shaped weld element 92 is fixed to one end of the bottom support tube 91 and hinged to the center support seat through a pin. The other end of the bottom support tube 91 is hinged to the bottom rack seat 42 at the lower end of the vertical tube 45. The bottom support tube 91 rotates upwards until the U-shaped weld element 92 presses against the center support seat 93. The U-shaped weld element 92 is rotatable by 90°.

To fold the trolley, the center support seat 93 of the trolley rack is lifted. The four U-shaped weld elements 92 and the bottom support tubes 91 rotate around an axis and get close, thereby driving the four vertical tubes 45 to get close inward. The long tubes 68 hinged to two sides of L-shaped iron element 46 and the foldable long tubes 481 simultaneously get close inward. Due to the double X-shaped crossed structures of the sidewalls, the inward get-close of the long tubes 68 drives the inward get-close of the two short tubes 69, and the double-end sliders 44 slide upwards on the vertical tubes 45 (FIG. 15C). Similarly, the foldable long tubes 481 drive the foldable short tubes 441 to move inward and push the double-end sliders 44 to slide upwards on the vertical tubes 45. In this way, the front frame, the rear frame, and the two side frames get close inward. As the long tubes 68 get close and rise, the side guardrail tubes 41 hinged to the two sides of the connecting element 67 gradually rise. Due to the fixed height of the sliding sleeve 42, the side guardrail tube 41 passing through the sliding sleeve 42 can only rotate with the sliding sleeve 42 and slide outward. At this point, as the front and rear walls get close, the front guardrail tubes 47 of the front frame and the rear frame hinged to the guardrail tube seats 43 rotate around the axis of the hinged ends and get close. The two lower links 51 are folded together with the vertical tubes 45 until the front and rear casters collide (FIG. 15D).

Simply put, to fold the trolley, the center support seat 93 of the bottom rack is lifted, causing the four U-shaped weld elements 92 and the support tubes 91 to rotate around the axis and get close, thereby driving the four vertical tubes 45 to get close inward. Driven by the double-end sliders 44, the double X-shaped crossed structures of the side frame, the front frame and the rear frame synchronously get close. The side guardrail tubes 41 are pushed outward along the sliding sleeves 42, and the front guardrail tubes 47 on the guardrail tube seats 43 are folded inward (FIGS. 15C and 15D).

To unfold the trolley, the center support seat 93 of the bottom rack is pressed down such that the four U-shaped weld elements 93 and the bottom support tubes 91 rotate around the hinge axis and are open out. Meanwhile, the long tube 68 and the foldable long tube 481 are opened out, and the short tube 69 and the foldable short tube 441, which respectively form an X-shaped crossing with the long tube and the foldable long tube, are opened out. The double-end sliding sleeves 44 slide downwards along the vertical tubes 45, thereby pushing the front wall, the rear wall, and the side wall outward. The first guardrail tube 41 rotates with the sliding sleeve 42 and slides upwards. Thus, the first guardrail tube 41 hinged to the guardrail tube seat 43 is slowly unfolded from a folded state (FIG. 15C) until the U-shaped weld element 92 on the bottom support tube 91 presses against the center support seat 93.

Simply put, the steps to unfold the trolley are opposite to the steps to fold the trolley (FIG. 15B).

It should be noted that the drawings of Embodiment 1 and Embodiment 2 are basically mechanical production drawings of the product in the present disclosure. These drawings can basically outline the structure to be protected and described in the present application.

### Embodiment 3

In Embodiments 1 and 2, the guardrail tube (including the side guardrail tube 41 and the front guardrail tube 47) can also be modified into a telescopic structure similar to a fishing rod. When the trolley is folded, one part of the guardrail tube is retracted into the other part of the guardrail tube. When the trolley is unfolded, one part of the guardrail tube extends out of the other part of the guardrail tube.

The technical features that are not described herein can be implemented by or using a prior art, and will not be repeated herein. Of course, the above described are not intended to limit the present disclosure, the present disclosure is not limited to the above examples. Therefore, variations, modifications, additions or substitutions made by those skilled in the art within the essential scope of the present disclosure should also fall within the protection scope of the present disclosure.

1. A collapsible trolley with a guardrail, comprising a rack assembly, a pull handle assembly provided in front of the rack assembly, a push handle assembly fixed behind the rack assembly, and a caster assembly provided at a bottom of the rack assembly.

2. The collapsible trolley with the guardrail according to claim 1, wherein the rack assembly comprises a bottom rack, a front frame and a rear frame respectively provided at two ends of the bottom rack, and side frames respectively provided at left and right sides of the bottom rack, wherein the front frame is connected to the pull handle assembly, and the rear frame is connected to the push handle assembly.

3. The collapsible trolley with the guardrail according to claim 2, wherein each of the front frame and the rear frame comprises a horizontal tube, vertical tubes respectively welded to two ends of the horizontal tube, and a guardrail tube passing through tube sleeves respectively hinged to upper ends of the vertical tubes; and the guardrail tube is U-shaped and slidable in the tube sleeves; and
alternatively, each of the front frame and the rear frame is provided with two double-end sliders, wherein the two double-end sliders are slidable up and down on the vertical tubes; foldable short tubes are connected between the two double-end sliders; lower ends of the vertical tubes are respectively fixed to two L-shaped elements; two foldable long tubes are connected between the two L-shaped elements; first ends of the two foldable long tubes are respectively hinged to the two L-shaped elements, and second ends of the two foldable long tubes are hinged together; a side of each of the two foldable long tubes is hinged to a side of each of the foldable short tubes to form an X-shaped crossed structure; and upper ends of the vertical tubes are hinged to first ends of two guardrail tubes, and second ends of the two guardrail tubes are hinged together.

4. The collapsible trolley with the guardrail according to claim 2, wherein each of the side frames comprises two X-shaped cross-tube assemblies and a connecting element; each of the cross-tube assemblies comprises a long tube and a short tube; and the long tube is hinged to the short tube through a first hole in a middle of a side of the long tube and a second hole in a middle of a side of the short tube;
first ends of the two long tubes are respectively hinged to the horizontal tubes or L-shaped elements of the front frame and the rear frame, and second ends of the two long tubes are hinged to the connecting element; and two free ends of two guardrail tubes are hinged to the connecting element of a same side frame; and
first ends of the two short tubes are hinged together, and second ends of the two short tubes are respectively hinged to two sliding sleeves or double-end sliders; and the two sliding sleeves are respectively slidable up and down on the vertical tubes of each of the front frame and the rear frame.

5. The collapsible trolley with the guardrail according to claim 2, wherein the bottom rack comprises a front bottom rack and a rear bottom rack; a front end of the front bottom rack is hinged to the horizontal tube of the front frame, and a rear end of the front bottom rack is hinged to a front end of the rear bottom rack; a rear end of the rear bottom rack is hinged to the horizontal tube of the rear frame, and a top of the front end of the rear bottom rack is transversely fixed to a steel strip; and the steel strip contacts the rear end of the front bottom rack; and
alternatively, the bottom rack comprises a center support seat, four U-shaped weld elements hinged to an outer side of the center support seat, and bottom support tubes, wherein first ends of the bottom support tubes are respectively welded to the four U-shaped weld elements, and second ends of the bottom support tubes are respectively hinged to U-shaped iron elements of the vertical tubes.

6. The collapsible trolley with the guardrail according to claim 1, wherein the pull handle assembly comprises a link seat, two lower links with first ends respectively connected to two sides of the link seat at an angle, a horizontal tube with two ends respectively connected to the two lower links, and an upper link vertically and slidably passing through a center of the link seat; the two lower links are symmetrically distributed about a central axis of the upper link; the two ends of the horizontal tube are respectively connected to second ends of the two lower links through pin shafts; and the pin shafts are respectively connected to torsion springs; and
a lever button is slidably provided inside a pull handle lever; the lever button is fixed to a top of the upper link; one end of the upper link is integrally connected to the pull handle lever; and a locking mechanism controlled by a pull handle button is provided in the upper link.

7. The collapsible trolley with the guardrail according to claim 6, wherein the locking mechanism comprises a steel bar with a first end pushed against the lever button and a pressing element fixedly connected to a second end of the steel bar; the pressing element is located above two limiting elements and inserted into a tube plug together with the two limiting elements; and a spring is located between the two limiting elements; and
a lower part of the pressing element is provided with a V-shaped opening; and two slopes of the V-shaped opening are respectively tangent to slopes of the two limiting elements.

8. The collapsible trolley with the guardrail according to claim 1, wherein the caster assembly comprises a front caster assembly and a rear caster assembly; the front caster assembly or the rear caster assembly comprises a caster carrier, a tire connected to the caster carrier through a pin shaft, a caster stem with an end fixed to a top of the caster carrier, and a stem sleeve sleeved on an outer side of the caster stem; and a quick release button and a spring are provided in a transverse square hole at an upper end of the stem sleeve and pressed into a lower end of each of the vertical tubes of the front frame or the rear frame.

9. The collapsible trolley with the guardrail according to claim 1, wherein a canopy assembly is provided above the rack assembly; the canopy assembly comprises an upper canopy seat, a lower canopy seat connected to a lower end of the upper canopy seat through a pin, two first transverse support tubes with first ends respectively hinged to an outer side of the upper canopy seat, two second transverse support tubes with first ends respectively hinged to an outer side of the lower canopy seat, side seats respectively hinged to second ends of the two first transverse support tubes and second ends of the two second transverse support tubes, and vertical posts with respective upper ends inserted into the side seats and lower ends inserted into canopy fixing seats; and the canopy fixing seats are respectively fixed to guardrail tubes.

10. The collapsible trolley with the guardrail according to claim 3, wherein the guardrail tube is formed into a telescopic structure.
